(19) United States
(12) Patent Application Publication
(10) Pub. No.: US 2011/0115751 A1
(43) Pub. Date: May 19, 2011

(54) HAND-HELD INPUT DEVICE, SYSTEM COMPRISING THE INPUT DEVICE AND AN ELECTRONIC DEVICE AND METHOD FOR CONTROLLING THE SAME

(75) Inventor: Mats WERNERSSON, Helsingborg (SE)

(73) Assignee: Sony Ericsson Mobile Communications AB, Lund (SE)

(21) Appl. No.: 12/621,847

(22) Filed: Nov. 19, 2009

(51) Int. Cl. G06F 3/033

(52) U.S. Cl. 345/179

(57) ABSTRACT

The present invention relates to a hand-held input device for performing an input in an electronic device, a system comprising the input device and the electronic device and a method for controlling the same, which are particularly useful for performing an input operation in three-dimensional environments, to realize a 3D interface and help a user to operate the 3D interface. The input device to be held by a user for performing an input in an electronic device comprises an obtaining section operable to obtain a signal; a feedback section operable to provide feedback to said user by a physical change in said input device; and a controller adapted to control said feedback section to provide said feedback to be sensed by said user when said obtaining section obtains said signal.

### FIELD OF THE INVENTION

The present invention relates to a hand-held input device for performing an input in an electronic device, a system comprising the input device and the electronic device and a method for controlling the same, which are particularly useful for performing an input operation in three-dimensional environments.

### BACKGROUND

Several different applications for touch screens are known in the art. For example, touch screens are used as man-machine interfaces for controlling the operation of large machines, appliances for the kitchen, all sorts of consumer electronics, mobile phones, etc. Commonly in touch sensitive devices, a touch-sensitive area is used in conjunction with a display so that a user may view through the transparent touch-sensitive area different icons relating to different functions of the device to be controlled. By touching or pressing the touch-sensitive area at the position of a specific icon, the function corresponding to this function is carried out. For example, a specific function of the device is started, e.g. a call is accepted or terminated, a piece of music is started, a picture is taken, etc.

Depending on the touch screen, e.g. resistive or capacitive touch screen, there are different ways of touching the same and triggering a function to be carried out. Performing an input to trigger a function, may be done using simply a finger or a special pointing instrument. An example for a pointing instrument is a stylus, which is usually pointed and used as an input device for entering commands or inputting letters or symbols on a touch screen.

Up to now touch screens have been limited to two dimensions, i.e. displayed icons are distributed on a two-dimensional display corresponding to specific x,y-positions. However, in recent years three-dimensional (3D) displays have been made available by different manufacturers providing a viewer with 3D images. This may be achieved with a larger number of micro-lenses or prisms placed on a specifically adapted display, wherein lenses and prisms may be provided in a special optical thin-film that may be used on top of a ore or less conventional display so that a left eye and a right eye of a user are provided with different information to cause stereo vision in the brain.

Therefore, it is possible to provide 3D images. However, it would be desirable to provide a 3D interface, in which icons are not limited to two dimensions but may be displayed in 3D and/or distributed in space. In this context, it is also desirable to provide an input device that helps a user to operate the 3D interface, e.g. a 3D display device.

### DISCLOSURE OF THE INVENTION

A novel input device to be held by a user for performing an input in an electronic device and a method for controlling the operation of the same are presented in the independent claims. Advantageous embodiments are defined in the dependent claims.

An embodiment of the invention provides an input device to be held by a user for performing an input in an electronic device. The input device comprises an obtaining section operable to obtain a signal, a feedback section operable to provide feedback to the user by a physical change in the input device, and a controller adapted to control the feedback section to provide the feedback to be sensed by the user when the obtaining section obtains the signal.

Accordingly, even if the user presses in a virtual image a virtual button or icon appearing to stick out from the real display surface, the user may be provided with a feedback of the input device acknowledging the pressing of the button or icon. Therefore, in contrast to a case, in which the user does not feel anything on his/her hand or finger when pressing a virtual button in 3D space, the user is provided with feedback acknowledging his/her input operation. Consequently, it is possible to design 3D interfaces taking advantage of the extra dimension of 3D images.

In one embodiment, the feedback section is adapted to generate a mechanical force to provide haptic feedback. Accordingly, a mechanical change in the input device may be felt by the user acknowledging an input operation.

In one embodiment, the feedback section comprises a material adapted to change its shape depending on electric energy supplied thereto so as to provide haptic feedback. Accordingly, by supplying an electric current, e.g. from a battery in the input device, a change in shape of at least parts of the input device is triggered so that the user receives haptic feedback.

In one embodiment, the feedback section comprises a mechanical actuator to provide haptic feedback, wherein the mechanical actuator is preferably adapted to move a member with respect to the input device so that the movement of the member is detectable by the hand of the user. Accordingly, the movement of the member in the direction of the hand or fingers of the user may be directly detected by the user providing a feel similar to a reaction force when touching a surface.

Alternatively, the mechanical actuator may be adapted to move a member in a longitudinal direction of the input device to a stop position so that the stop of the movement is detectable by the user. Accordingly, the input device imitates a situation that is felt by the user if the input device were pressing against a real surface and is subject to a reaction force, i.e. counteracting force to the normal force acting upon a real body. In other words, the classical result of Newton's law is imitated by providing a reaction on a pressing action by an opposite force.

For example, the mechanical actuator comprises at least one of an electro-activated polymer, an electromagnet, a piezoelectric material, and a buzzer motor to provide haptic feedback. Accordingly, one or more of the above may be used to provide a realistic feeling of a reaction to the user.

In one embodiment, the feedback section is adapted to supply an electric current to provide electrical or optical feedback. Accordingly, an electric energy supply, such as a battery, which is available in very small sizes may be provided to supply an electric current to activate feedback.

In one embodiment the signal depends on the relative position of the input device with respect to the electronic device. Accordingly, the signal provided to the obtaining section indicates the relative positions which may correspond to a virtual button or icon that is to be pressed. That is, a signal is transmitted and then received when the relative position corresponds to a virtual button or icon but otherwise not, for example.

In one embodiment, the obtaining section comprises a communication section configured to receive the signal or a detection section configured to detect the signal. Accordingly, the input device may either be provided with a passive obtaining section waiting to receive a signal, e.g. from the electronic device, or with an active obtaining section that detects the signal by its own, e.g. by sending out a transmission signal and detecting a reception signal which is the transmission signal affected by physical interactions after transmission.

Another embodiment of the invention provides a system comprising an electronic device and the above-described input device, wherein the electronic device comprises a position detection module operable to detect the position of the input device and a communication module operable to transmit the signal to the input device. Accordingly, a system is provided that allows the input device to communicate with an electronic device that receives an input.

Another embodiment of the invention provides a method for controlling the operation of a hand-held input device, and comprises the steps of obtaining a signal, and providing feedback to the user by affecting a physical change in the input device to be sensed by the user when the signal is obtained.

Another embodiment of the invention provides a method for controlling the operation of a system comprising an electronic device and a hand-held input device, comprising the steps of detecting the position of the input device by the electronic device, transmitting the signal to the input device, obtaining the signal at the input device, and providing feedback to the user by effecting a physical change in the input device to be sensed by the user when the signal is obtained.

### BRIEF DESCRIPTION OF THE DRAWINGS

Embodiments of the invention will be described with respect to the following appended figures.

FIG. 1 illustrates an input device and elements thereof according to an embodiment of the invention.

FIGS. 2a, 2b and 2c illustrate different examples of input devices according to specific embodiments of the invention.

FIG. 3a illustrates a system comprising an input device and an electronic device, in particular showing the interplay of the two devices.

FIG. 3b illustrates a cross-sectional view of the system shown in FIG. 3a.

FIG. 4 illustrates a flow diagram of a method controlling the operation of a hand-held input device according to an embodiment of the invention.

FIG. 5 illustrates a flow diagram of a method for controlling the operation of a system according to an embodiment of the invention.

### DESCRIPTION OF THE EMBODIMENTS

Embodiments of the invention are described with reference to the Figures. It is noted that the following description contains examples only and should not be construed as limiting the invention.

In the following, similar or same reference signs indicate similar or same elements.

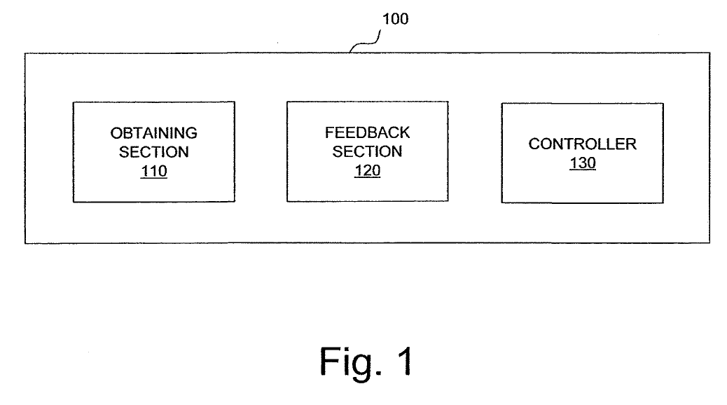

FIG. 1 illustrates elements of an input device according to an embodiment of the invention. In detail, FIG. 1 illustrates the input device 100 comprising an obtaining section 110, a feedback section 120 and a controller 130.

The input device 100 is a hand-held input device to be held by a user for performing an input operation in an electronic device, such as a desktop computer with a 3D display and/or 3D touch pad/screen, a mobile device like a portable computer or some kind of mobile phone, some kind of machine like kitchen appliances or industrial machines, etc. For example, the input device is a stylus, a pointed instrument used for entering commands or inputting letters or symbols on a touch screen or 3D display, such as the one described below.

The obtaining section 110 obtains a signal, such as a signal indicating that the input device is at a specific position in 3D space with respect to the electronic device, wherein this position may correspond to a virtual icon or button displayed by a 3D display of the electronic device. The obtaining section 110 is an example of means for obtaining a signal.

For example, the electronic device may transmit a signal to the input device when the electronic device senses that the input device is at a particular position corresponding to a virtual button. In detail, the electronic device may detect a tip of the input device 100 corresponding to a specific position and send out a signal. In this example, sending the signal is dependent on the relative position of the input device with respect to the electronic device. There are different possibilities for the electronic device to sense a position, and for details, it is referred to the sections below.

The electronic device and the input device 100 may communicate via Bluetooth or other short-range wireless communication, such as Wi-Fi or similar. In such a case, the input section 110 is adapted to receive the signal from the electronic device wirelessly via some kind of short-range communication. Several IEEE standards are available to realize such a communication, such as IEEE 802.11 or IEEE 802.15.1.

On the other hand, the obtaining section 110 may obtain a signal by actively detecting the relative position of the input device 100 with respect to the electronic device, e.g. by infrared radiation; details will be described below.

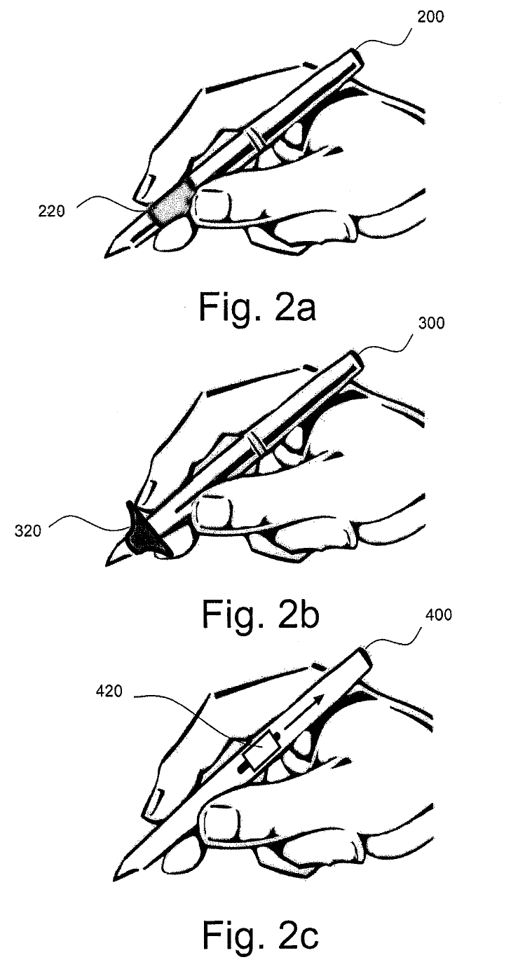

The feedback section 120 is operable to provide feedback to a user of the input device 100 by a physical change in the input device 100. There are several different kinds of feedback sections that may be used as a feedback section 120, wherein some specific examples will be discussed with respect to FIGS. 2a, 2b and 2c. In general, the feedback section 120 is part of the input device 100 and can change its physical properties which can be detected by the user by the known human senses. The feedback section 120 is an example of means for providing feedback.

According to one example, several physical changes may be used so that haptic feedback is provided to give the user a sense of touching a surface that seems to be present in a 3D image but is actually not there in reality. For example, a mechanical change in the properties by a mechanical force generated in the feedback section 120 provides haptic feedback or feedback may be obtained by a small electric pulse in the feedback section that can be felt by the user. Here, electrical feedback may also be regarded as haptic feedback since the electric current can be sensed by the user.

A simple way of feedback is optical feedback, wherein a light, e.g. a light emitting diode, on the input device turns on. However, haptic feedback seems to be preferable, since the feedback is directly provided to the hand of the user holding the input device and gives the user a sense of touching a surface.

The controller 130 is adapted to control the feedback section 120 to provide feedback. This feedback can then be sensed by the user, especially the hand of the user, as described above. In particular, the controller controls the feedback section to provide feedback, when the obtaining section 110 obtains the signal. In more detail, the obtaining section 110 obtains the signal and informs the controller thereof, whereupon the controller 130 instructs the feedback section 120 to change its physical properties to provide feedback. The controller 130 is an example of means for controlling the means for providing feedback.

The skilled person understands that the controller 130 itself may also be part of the obtaining section 110 or feedback section 120 so that when the controller 130 is part of the obtaining section 110, the obtaining section 110 instructs the feedback section 120 directly to provide feedback.

According to the above, an image of a virtual keyboard may be presented to the user via a 3D display device, whereas the user may use the input device 100 to perform input operations on the virtual keyboard or keypad and receives feedback from the input device when pressing a virtual key.

FIG. 2a illustrates a specific example of an input device. As can be seen in the Figure, the input device 200, here illustrated as a stylus, is held by a hand, wherein the thumb, the index finger and the middle finger touch a grey area of the input device 200 constituting a feedback section 220. In FIG. 2a as well as in FIGS. 2b and 2c, the obtaining sections and controllers are not visible, since they are preferably placed within the input devices 200, 300 and 400, but these elements provide similar functions to the functions described above with respect to FIG. 1.

In the example of FIG. 2a, the feedback section 220 is a haptic feedback section and comprises a material adapted to change its shape depending on electric energy supplied thereto. In detail, the feedback section 220 may shrink or expand in diameter. This is, since the user touches the feedback section 220 the diameter change will be felt by the user and give the appropriate feedback, when pressing a virtual key, for example.

The material that may be used to realize the input device 200 of this example is an electro-activated polymer (EAP). An EAP is a material that expands when an electric field is applied thereto. Therefore, a battery may be provided in the input device 200 that supplies an electric current to build up an electric field that is applied to the material.

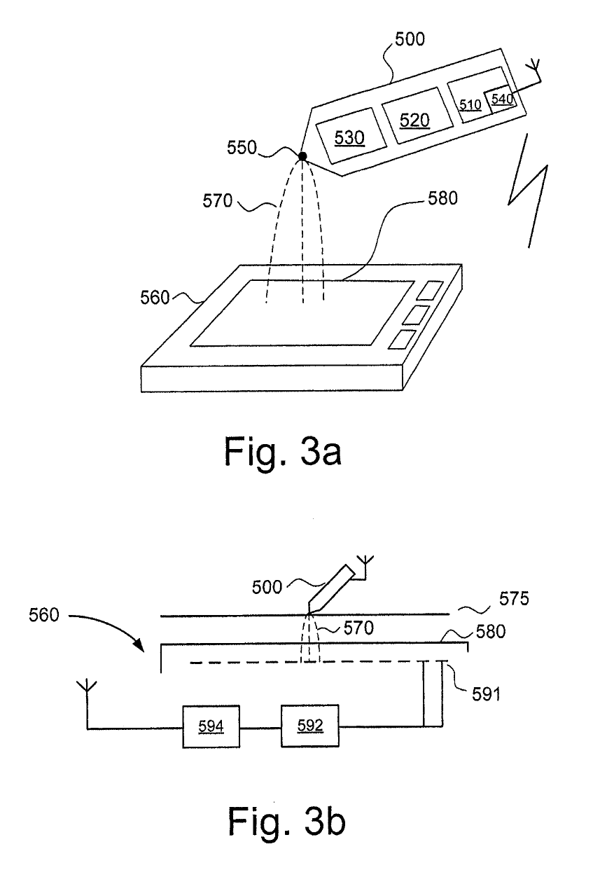

Further, this material is also suitable to allow variations in feedback to the user. For example, the feedback section 220, i.e. the grey part, expands more as the input device 200 is pressed further down, i.e. the tip of the input device 200 comes closer to the real surface of the electronic device (not shown in this Figure but discussed with respect to FIG. 3).

Here, the feedback section, in particular the material, acts like a mechanical actuator. For example, if a virtual 3D key (button or icon) of a keyboard is displayed, the deeper down the key is pressed, the more the feedback section 220 expands. Therefore, an intuitive, natural feeling of pressing harder against a surface, in this case only a virtual surface, can be provided. Details of the electronic device and its interplay with the input device are presented later in FIGS. 3a and 3b.

In FIG. 2b another specific example of an input device is shown. The input device 300 comprises a feedback section 320, the visible part of it being cone-shaped for illustration purposes and constituting a collar type structure. This collar type structure may act as a mechanical actuator moving a member comprised therein, such as the grey part in FIG. 2b, with respect to the input device 300 so that the movement of the member is detectable by the hand of the user. In other words, the collar-type structure constitutes or comprises a member, wherein the member is part of the mechanical actuator or may be moved by the mechanical actuator.

Accordingly, The feedback section 320 partly realized as a collar type structure around the input device 300 introduces a force or movement towards the fingertip of the user. The collar type structure, or at least part of it, may be constructed of EAP as in the previous example to provide a change in shape when an electric field is applied.

Alternatively, also an electromagnet, piezo actuator, e.g. any kind of piezo material, or similar may be used as mechanical actuator moving a member back and forth on the shaft of the input device 300.

In FIG. 2c another specific example of an input device is illustrated. The input device 400 of FIG. 2c comprises a different kind of feedback section as described above. The feedback section 420, shown in FIG. 2c, is actually placed inside the input device 400 which is shown transparent for clarity so that a part of the feedback section 420 is visible. This part is a member, such as a rod, that may be moved in longitudinal direction of the input device 400, as indicated by the arrow in FIG. 2c.

The rod in FIG. 2c may be accelerated and moved in the direction of the arrow and as the rod reaches a stop position, the user may sense a “tap” similar to touching a real (hard) surface. In other words, the de-acceleration at the stop position is detectable by the user. Preferably the rod is accelerated slowly from a start position and abruptly stopped at a stop position so that the force generated by the stop is easily detectable by the user's hand. Here, a rod is just one example of a member that may be used and also other members with a certain mass can be used.

There are also several mechanisms to move the rod, such as an electromagnet. For example, the rod itself may be a small permanent magnet and by supplying an electric current to the electromagnet and creating a magnetic field of the same pole in the direction of the rod as the pole of the rod itself, a repelling force is provided between the electromagnet and the rod moving the rod in the direction of the arrow.

Alternatively or additionally, also a buzzer motor, such as the kind used in mobile phones to effect vibration, may also be used in a feedback section 220, 320, 420 in the above-described examples.

To obtain an even more realistic feeling two or more of these examples may be combined.

In the following, the use of such an input device 100, 200, 300, 400 in conjunction with an electronic device will be described with respect to FIGS. 3a and 3b.

In FIG. 3a an input device 500 and an electronic device 560 are shown constituting a system.

The input device 500 comprises an obtaining section 510 having a communication section 540, a feedback section 520, a controller 530 and a tip 550.

The feedback section 520 may be realized by at least one of the above-described feedback sections 120, 220, 320 and 420 so that it is referred to the previous description of these sections to avoid unnecessary repetition.

Furthermore, the controller 530 may control the input device 500, and in particular the feedback section 520 in the same way or similar way as described above. The controller 530 may be realized by a hardware arrangement, such as by hardwired circuits, or ASICs (application specific integrated circuits) or a microprocessor or other integrated circuit running several software elements, for example, software elements corresponding to the functions of the above-described controller.

As shown in FIG. 3a, the obtaining section 510 comprises a communication section 540 having an antenna. Basically, it should be sufficient for the communication section to be able to receive a signal so as to constitute a simple receiving section. The signal may be obtained through the antenna from the electronic device 560. The electronic device 560 is shown as a small device with a display device 580. In this example, the electronic device 560 may be a smart phone, a mobile or cellular phone which can be used to perform several functions apart from the standard communication via GSM, UMTS, AMPS, etc.

Furthermore, lines of electric flux 570 are indicated for illustrative purposes, when assuming that the electronic device 560 has a display 580 adapted as a touch screen as commonly used in smart phones.

Details of the interaction between the input device 500 and the electronic device 560 will now be described with respect to FIG. 3b illustrating a cross-sectional view of the system described with respect to FIG. 3a.

In FIG. 3b the input device 500 with the antenna is again shown. The tip 550 of the input device 500 is placed on a virtual surface 575 above the real surface of the display 580. Below the upper surface of display 580 there are provided electrodes 591 realizing a capacitive touch screen area. Namely, a change in capacitance between an electrode and an object above or on the surface of the display device 580 may be regarded as a touch triggering a function in the electronic device 560. It is noted that in this example of a 3D interface, physically touching the display 580 is not necessary anymore since the input device 500 performs input operations on virtual keys without necessarily touching the real display 580.

The electronic device 560 further comprises a position detection module 592 operable to detect the position of the input device 500 and a communication module 594 having an antenna and being operable to transmit a signal to the input device 500. The position detection module 592 cooperates with the electrodes 591 as follows.

Similar to a common capacitive touch screen, electrodes 591 are placed below the upper surface of the display 580 and distributed in a two-dimensional plane so as to provide for the x,y-position detection of a touch screen on the display 580. In the electronic device 560 of FIG. 3b, in addition to the x,y-position, the position detection module 592 coupled with the electrodes 591 is also sensitive to the z-direction, i.e. it is possible to detect the x,y,z-position of the input device 500.

Similar to FIG. 3a, the lines of electric flux 570 are shown in FIG. 3b. In the example shown, the input device 500 comprises a conductive metal piece at the tip 550 of the input device 500 that forms a counterpart to the electrodes 591 thus constituting a capacitor. Therefore, depending on the strength of the lines of electric flux, a position in space, i.e. x,y,z-position of the input device 500 can be detected, namely the position on a virtual surface 575 as shown in FIG. 3b. If this position corresponds to a virtual key or button, the position detection module 592, after detecting the position, informs the communication module 594 thereof.

The communication module 594 transmits a signal to the input device 500 via the antenna shown in FIG. 3b. As described above, when the signal is obtained at the obtaining section 510 via the communication section 540 receiving the signal via the antenna, the controller 530 is informed thereof and controls the feedback section 520 to provide feedback to the user by a physical change so that the user senses a mechanical force, for example, and gets the impression of touching a real surface that seems to be present but is not really there, since it is a virtual surface.

In other words, the system shown in FIG. 3b combining the input device 500 and the electronic device 560 has so-called pre-sense, i.e. it can read the z-position as well as the x- and y-position, and when the tip of the input device 500 touches the virtual surface 575 that appears to be located above the display 580, the input device 500 generates a mechanical force that the user can sense. Therefore, the extra dimension of a 3D display can be used as a 3D interface either by having 3D keys to be pressed or it is even feasible to distribute several keys or icons in the z-direction so that a larger number of keys or icons can be chosen from compared to keys or icons distributed in two dimensions only.

In the above example relating to FIG. 3b, it has been described that a signal is sent, using the above short range communication, from the communication module 594 to the obtaining section 510 to trigger feedback. This signal may thus be very simple, but also the case can be considered in which the signal changes with the distance between the display 580 and the tip 550 so that accordingly also the feedback can be changed. For example, the closer the tip 550 gets to the display 580, i.e. the harder the virtual key is pressed down, the stronger the feedback provided by the feedback section 520.

Furthermore, it is understood that also other signals may be sent from the communication module 594 to the communication section 440 of the obtaining section 510 instructing the input device 500 either to provide feedback or not. It is not necessary that information regarding the x,y,z-position of the input device 500 is actually sent to the input device 500 from the electronic device 560 since the input device 500 only needs to know when to provide feedback.

The skilled person may easily understand that also other methods of detecting the relative position between the tip of the input device 500 and the display 580 of the electronic device 590 are available.

For example, in addition or as an alternative to detecting the tip 550 by the electronic device 560 via capacitance effects or resistance or infrared distance measurements, the obtaining section 510 may comprise a detecting section (not shown) detecting infrared rays transmitted either from the input device 500 itself or from the electronic device 560. For example, infrared diodes are placed at the corners of the display 580 of the electronic device 560 and the detecting section of the input device 500 comprises a photodiode or photodiodes, e.g. in the tip 550, and the input device 500 determines its position by triangulation or similar methods. Similarly, it is also feasible to provide an infrared diode in the tip of the input device 550 and infrared detectors around the display 580 so that a position of the input device 500 may be determined at the electronic device 560 using the infrared detectors.

Since the electronic device 560 provides the 3D display tha is able to project virtual buttons or keys, and thus knows their locations, it is preferable that the relative position of the input device with respect to the electronic device 560 is determined in the electronic device 560 so that the communication module 594 only has to send a signal to indicate to the input device 500 to provide feedback to the user when the position of the input device corresponds to a virtual key.

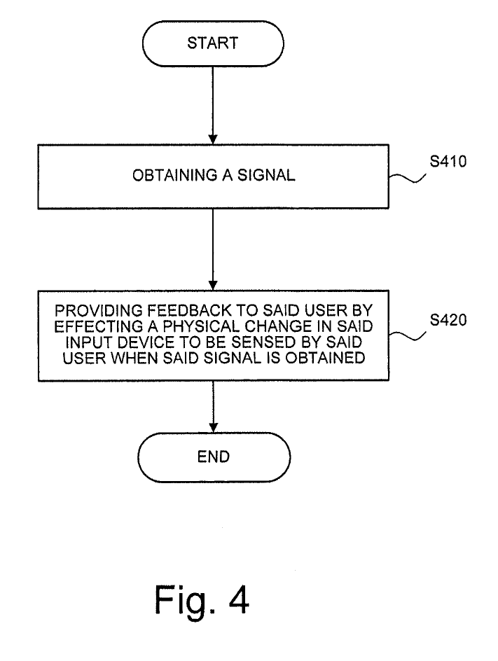

In the following, steps of a method for controlling the operation of the hand-held input device 100, 200, 300, 400, 500 will be described with respect to FIG. 4.

In a first step S410, a signal is obtained. As described above, the signal may be a measurement signal related to a position measurement performed by the input device itself or may preferably be a simple signal from the electronic device comprising information to indicate that the controller of the input device is to control the feedback section to provide feedback.

Then, in step S420, feedback is provided to the user by effecting a physical change in the input device, which is sensed by the user, wherein feedback is provided after obtaining the above-described signal.

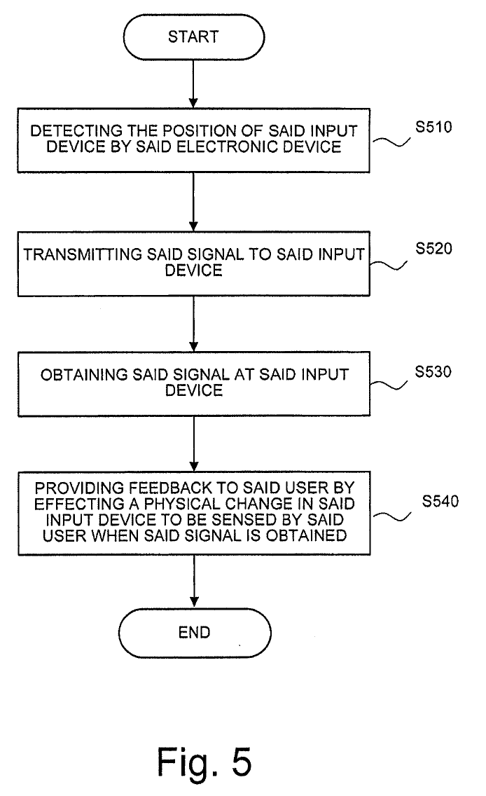

In FIG. 5 steps of a method for controlling the operation of the whole system comprising the electronic device and the hand-held input device, such as the electronic device 560 and the input device 100, 200, 300, 400 or 500 will be described.

In step S510 the position of the input device is detected by the electronic device. When the position is obtained, the position is compared to the locations of virtual keys or buttons to determine whether a virtual key or button is pressed. If it is determined by the electronic device that a virtual key or button is pressed, the method flow proceeds to step S520 in which a signal is transmitted to the input device. In particular, as described above, the communication module 594 transmits the signal.

Then, in step S530 the signal is obtained at the input device and in step S540 feedback is provided to the user by effecting a physical change in the input device to be sensed by the user once the signal is obtained.

The above description has mentioned several individual elements, such as the obtaining section 110, 510, the feedback section 120, 220, 320, 420, 520, the controller 130, 530, the position detection module 592 and the communication module 594, and it should be understood that the invention is not limited to these elements being independent structural units but these elements should be understood as elements comprising different functions. In other words, it is understood by the skilled person that an element in the above-described embodiments is not construed as being limited to a separate tangible part but it is understood as a kind of functional entity so that several functions may also be provided in one tangible part or even where an element, such as the controller that may comprise a processor or other processing means may perform several functions, these functions may be distributed to different parts.

Moreover, physical entities according to the invention and/or its embodiments and examples may comprise or store computer programs including instructions such that, when a computer program is executed on the physical entity, such as a controller, processor, CPU or similar, steps, procedures and functions of these elements are carried out according to the embodiments of the invention.

For example, specially programmed software is used to be run on a processor, e.g. contained in the controller, to control the above-described functions, such as controlling the feedback section by instructing it to provide feedback. The invention also relates to computer programs for carrying out functions of these elements, such as the method steps described with respect to FIGS. 4 and 5.

The above-described elements of the input devices 100, 200, 300, 400 and 500 and elements of the electronic device 560 may be implemented in hardware, software, field-programmable gate arrays (FPGAs), application-specific integrated circuits (ASICs), firmware or the like, wherever appropriate.

It will be appreciated that various modifications and variations can be made in the described elements, input devices, electronic device, system and methods as well as in the construction of this invention without departing from the scope or spirit of the invention. The invention has been described in relation to particular embodiments which are intended in all aspects to be illustrative rather than restrictive. Those skilled in the art will appreciate that many different combinations of hardware, software and firmware are suitable for practicing the invention.

Moreover, other implementations of the invention will be apparent to the skilled person from consideration of the specification and practice of the invention disclosed herein. It is intended that the specification and the examples are considered as exemplary only. To this end, it is to be understood that inventive aspects may lie in less than all features of a single foregoing disclosed implementation or configuration. Thus, the true scope and spirit of the invention is indicated by the following claims.

1. Input device to be held by a user for performing an input in an electronic device, comprising
an obtaining section operable to obtain a signal;
a feedback section operable to provide feedback to said user by a physical change in said input device; and
a controller adapted to control said feedback section to provide said feedback to be sensed by said user when said obtaining section obtains said signal.

2. Input device of claim 1, wherein said feedback section is adapted to generate a mechanical force to provide haptic feedback.

3. Input device of claim 1, wherein said feedback section comprises a material adapted to change its shape depending on electric energy supplied thereto so as to provide haptic feedback.

4. Input device of claim 1, wherein said feedback section comprises a mechanical actuator to provide haptic feedback.

5. Input device of claim 4, wherein said mechanical actuator is adapted to move a member with respect to said input device so that said movement of said member is detectable by the hand of said user.

6. Input device of claim 4, wherein said mechanical actuator is adapted to move a member in a longitudinal direction of said input device to a stop position so that the stop of said movement is detectable by said user.

7. Input device of claim 4, wherein said mechanical actuator comprises at least one of an electro activated polymer, an electro magnet, a piezoelectric material, and a buzzer motor to provide haptic feedback.

8. Input device of claim 1, wherein said feedback section is adapted to supply an electric current to provide electrical or optical feedback.

9. Input device of claim 1, wherein said signal being dependent on the relative position of the input device with respect to said electronic device.

10. Input device of claim 1, wherein said obtaining section comprises a communication section configured to receive said signal or a detecting section configured to detect said signal.

11. Hand-held input device for performing an input in an electronic device, comprising
means for obtaining a signal;
means for providing feedback to said user by effecting a physical change in said input device; and
means for controlling said means for providing feedback to provide said feedback to be sensed by said user when said means for obtaining obtains said signal.

12. System comprising an electronic device and said input device according to claim 1, wherein said electronic device comprises
a position detection module operable to detect the position of said input device, and
a communication module operable to transmit said signal to said input device.

13. Method for controlling the operation of a hand-held input device, comprising the steps
obtaining a signal; and
providing feedback to said user by effecting a physical change in said input device to be sensed by said user when said signal is obtained.

14. Method for controlling the operation of a system comprising an electronic device and a hand-held input device, comprising the steps
detecting the position of said input device by said electronic device;
transmitting said signal to said input device;
obtaining said signal at said input device; and
providing feedback to said user by effecting a physical change in said input device to be sensed by said user when said signal is obtained.
